(19) United States
(12) Patent Application Publication
(10) Pub. No.: US 2024/0313551 A1
(43) Pub. Date: Sep. 19, 2024

(54) VOLTAGE SUPPLY DEVICE AND POWER GENERATION CONTROL METHOD

(71) Applicant: HONDA MOTOR CO., LTD., Tokyo (JP)

(72) Inventor: Kenji Noguchi, Wako-shi (JP)

(21) Appl. No.: 18/598,683

(22) Filed: Mar. 7, 2024

(30) Foreign Application Priority Data
Mar. 15, 2023 (JP) 2023-040719

(51) Int. Cl. H02J 7/00; H02J 7/34; B60L 50/60; B64C 29/00; B64D 27/357

(52) U.S. Cl. CPC H02J 7/00308; H02J 7/0031; H02J 7/0047; H02J 7/345; B60L 50/60; B60L 2200/10; B64C 29/0008; B64D 27/357

(57) ABSTRACT

A voltage supply device for supplying DC voltage generated by a power generation unit to a load, including: a voltage acquisition unit that acquires a first voltage that is the voltage of a smoothing capacitor and a second voltage that is the voltage of a battery; a computation unit that computes the difference between the first voltage and the second voltage; a judgment unit that judges that the smoothing capacitor is in an overvoltage state when the difference is no less than a predetermined threshold; and a power generation control unit that controls the power generation unit to suppress or stop power generation by the power generation unit when the smoothing capacitor is in an overvoltage state.

### CROSS-REFERENCE TO RELATED APPLICATIONS

This application is based upon and claims the benefit of priority from Japanese Patent Application No. 2023-040719 filed on Mar. 15, 2023, the contents of which are incorporated herein by reference.

### BACKGROUND OF THE INVENTION

### Field of the Invention

The present invention relates to a voltage supply device and a power generation control method.

### Description of the Related Art

JP 2022-158675 A discloses a power converter. A voltage sensor is provided to detect the voltage across the terminals of a smoothing capacitor used in the power converter.

### SUMMARY OF THE INVENTION

According to the disclosure of JP 2022-158675 A, it is necessary to monitor the voltage across the terminals of the smoothing capacitor in order to detect that the smoothing capacitor has come into an overvoltage state. When a detection error is taken into account, it is possible that the smoothing capacitor becomes large in capacity, resulting in that a voltage supply device is scaled up in size.

An object of the present invention is to solve the aforementioned problem.

A first aspect of the present invention is a voltage supply device for supplying direct-current voltage generated by a power generation unit to a load, the voltage supply device including a smoothing capacitor that smooths the direct-current voltage, a battery connected to the smoothing capacitor in parallel with the load, a voltage acquisition unit that acquires a first voltage that is the voltage of the smoothing capacitor and a second voltage that is the voltage of the battery, an arithmetic unit that computes a difference between the first voltage and the second voltage, a judgment unit that judges that the smoothing capacitor is in an overvoltage state when the difference is larger than or equal to a predetermined threshold, and a power generation control unit that controls the power generation unit to suppress or stop power generation performed by the power generation unit when it is judged that the smoothing capacitor is in the overvoltage state.

A second aspect of the present invention is a power generation control method for a voltage supply device that supplies direct-current voltage generated by a power generation unit to a load, the power generation control method including a voltage acquisition step of acquiring a first voltage that is the voltage of a smoothing capacitor that smooths the direct-current voltage, and a second voltage that is the voltage of a battery connected to the smoothing capacitor in parallel with the load, a computing step of computing a difference between the first voltage and the second voltage, a judgment step of judging that the smoothing capacitor is in an overvoltage state when the difference is equal to or larger than a predetermined threshold, and a power generation control step of controlling the power generation unit to suppress or stop power generation performed by the power generation unit when it is judged that the smoothing capacitor is in the overvoltage state.

According to the present invention, it is possible to prevent the voltage supply device from being enlarged.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic diagram of an aircraft;

FIG. 2 is a schematic diagram showing the structure of a voltage supply device of the aircraft;

FIG. 3 is a diagram for explaining a power generation control method according to one embodiment;

FIG. 4 is a flowchart showing a processing procedure according to the power generation control method; and

FIG. 5 is a diagram exemplifying a change in the required time for power generation control associated with an overvoltage judgment.

### DETAILED DESCRIPTION OF THE INVENTION

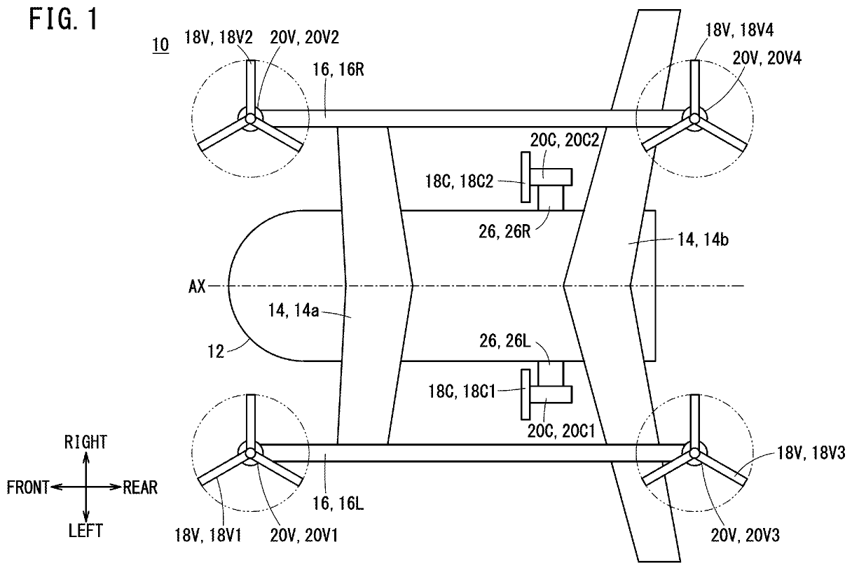

A voltage supply device and a power generation control method thereof according to an embodiment will be described with reference to the drawings. In the description of the present embodiment, an example of an aircraft is used as a mobile body having the voltage supply device, but the present invention is not limited to this example. FIG. 1 is a schematic view of an aircraft 10. The aircraft 10 is an Electric Vertical Take-off and Landing (eVTOL) aircraft. The aircraft 10 has a fuselage 12. The fuselage 12 is provided with a cockpit, a cabin, and the like.

The aircraft 10 is a tandem wing aircraft. The aircraft 10 has wings 14. The wing 14 includes a front wing 14a and a rear wing 14b. The rear wing 14b is a receding wing. When the aircraft 10 moves forward, lift is generated at each of the front wing 14a and the rear wing 14b. A boom 16L and a boom 16R are attached to the front wing 14a and the rear wing 14b.

The boom 16L extends in the front-rear direction along the centerline AX of the fuselage 12. The boom 16L is positioned to the left with respect to the centerline AX of the fuselage 12. The boom 16R extends in the front-rear direction along the centerline AX. The boom 16R is positioned to the right with respect to the centerline AX. The boom 16L and the boom 16R are arranged to be spaced apart from each other in the left-right direction with the fuselage 12 in between. When the boom 16L and the boom 16R are not distinguished, they may simply be referred to as boom 16.

The aircraft 10 has a plurality of rotors 18V. In FIG. 1, four rotors 18V1, 18V2, 18V3, and 18V4 are illustrated as the plurality of rotors 18V. Each rotor 18V is driven by one or more motors 20V. In FIG. 1, an example is shown in which each rotor 18V is driven by one motor 20V. A motor 20V1 is provided for the rotor 18V1. A motor 20V2 is provided for the rotor 18V2. A motor 20V3 is provided for the rotor 18V3. A motor 20V4 is provided for the rotor 18V4.

The rotor 18V is driven by the motor 20V, thereby generating thrust mainly in the vertical direction. The number of revolutions of the rotor 18V and the pitch angle of the blades of the rotor 18V are adjusted to control the thrust. The thrust at each rotor 18V is controlled, whereby the propulsion force is generated mainly upward with respect to the fuselage 12. Each rotor 18V is used mainly during vertical takeoff, during a transition from vertical takeoff to cruising, during a transition from cruising to vertical landing, during vertical landing, during hovering, and the like.

The two rotors 18V1, 18V3 are attached to the boom 16L. Correspondingly, the motors 20V1, 20V3 are also attached to the boom 16L. The remaining two rotors 18V2, 18V4 are attached to the boom 16R. Correspondingly, the motors 20V2, 20V4 are also attached to the boom 16R.

The aircraft 10 has a plurality of rotors 18C. In FIG. 1, two rotors 18C1 and 18C2 are illustrated as the plurality of rotors 18C. Each rotor 18C is driven by one or more motors 20C. In FIG. 1, an example is shown in which each rotor 18C is driven by one motor 20C. A motor 20C1 is provided for the rotor 18C1. A motor 20C2 is provided for the rotor 18C2.

Mounts 26 (mount 26L and mount 26R) are attached to side surfaces of the fuselage 12. The mount 26L extends leftward from the left side surface of the fuselage 12. The mount 26R extends rightward from the right side surface of the fuselage 12. The rotor 18C1, together with the motor 20C1, is attached to the mount 26L. The rotor 18C2, together with the motor 20C2, is attached to the mount 26R. Each rotor 18C may be attached to the fuselage 12 at a position rearward of the rear wing 14b.

The rotor 18C is driven by the motor 20C, which generates thrust mainly in the horizontal direction. The number of revolutions of the rotor 18C and the pitch angle of the blades of the rotor 18C are adjusted to control the thrust. The thrust at each rotor 18C is controlled, whereby the propulsion force is generated mainly forward with respect to the fuselage 12. Each cruise rotor 18C is used mainly during a transition from vertical takeoff to cruising, during cruising, during a transition from cruising to vertical landing, and the like.

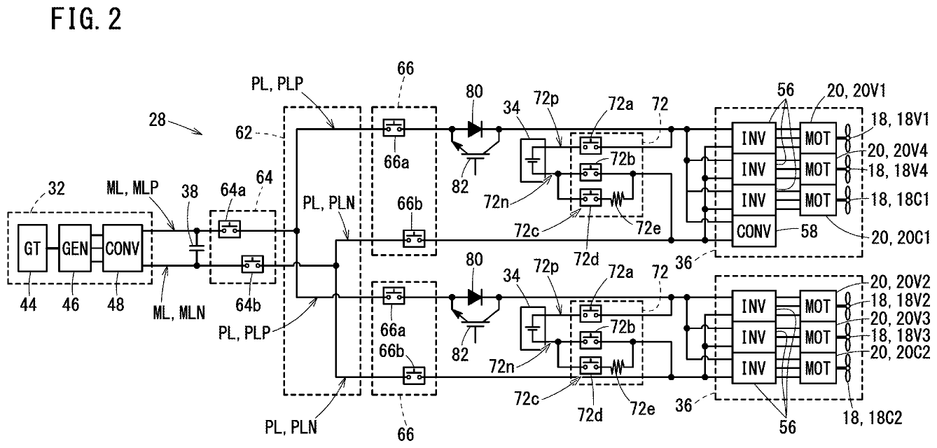

FIG. 2 is a schematic diagram showing the structure of a voltage supply device 28 of the aircraft 10. The aircraft 10 is a hybrid aircraft. Thus, the aircraft 10 has one or more power generation units 32 and one or more batteries 34. One power generation unit 32 is illustrated in FIG. 2. One voltage supply device 28 is provided for one power generation unit 32.

One voltage supply device 28 includes one or more batteries 34. In FIG. 2, an example is shown where one voltage supply device 28 includes two batteries 34. The voltage supply device 28 according to the present embodiment supplies the DC voltage generated by the power generation unit 32 or the DC voltage coming from the battery 34 to the loads 36 such as the multiple motors 20 (the above-described motors 20C and 20V). The DC voltage generated by the power generation unit 32 can also be used to charge the battery 34. The voltage supply device 28 has a smoothing capacitor 38, the battery 34, and circuit elements such as contactors described later.

The voltage supply device 28 further has a voltage supply line ML connected to the power generation unit 32 and a plurality of voltage supply lines PL branched from the voltage supply line ML. Each of the plurality of voltage supply lines PL is connected to each of the loads 36. In the example shown in FIG. 2, two voltage supply lines PL are shown. The voltage supply line ML includes a positive electrode wiring MLP and a negative electrode wiring MLN. Each voltage supply line PL includes a positive electrode wiring PLP and a negative electrode wiring PLN.

One smoothing capacitor 38 is provided for one power generation unit 32. The positive terminal and the negative terminal of the smoothing capacitor 38 are connected to the positive electrode wiring MLP and the negative electrode wiring MLN of the voltage supply line ML, respectively. The smoothing capacitor 38 smooths the DC voltage generated by the power generation unit 32. The smoothed DC voltage can be supplied to each load 36 or each battery 34 via the voltage supply lines ML and PL.

One battery 34 is connected to one voltage supply line PL. Multiple batteries 34 may be connected to one voltage supply line PL. The positive terminal and the negative terminal of each battery 34 are connected to the positive electrode wiring PLP and the negative electrode wiring PLN of the voltage supply line PL, respectively. The DC voltage from each battery 34 can be supplied to the load 36 by the voltage supply line PL. Also, as will be described later, at the start of the internal combustion engine 44, the DC voltage from the battery 34 can be supplied to the power generation unit 32 by the voltage supply line PL.

The aircraft 10 has the power generation unit 32, the voltage supply device 28, and the loads 36. The power generation unit 32 includes an internal combustion engine 44, a power generation unit 46, and a converter 48. The internal combustion engine 44 is, for example, a gas turbine. The power generation unit 46 generates electricity with power obtained from the internal combustion engine 44. The converter 48 converts the AC voltage coming from power generation unit 46 to the DC voltage.

The load 36 includes a plurality of rotors 18 (the above-described rotors 18C, 18V), a plurality of motors 20, and a plurality of inverters 56. Each inverter 56 converts the DC voltage coming from the smoothing capacitor 38 or the battery 34 to the AC voltage. Each motor 20 drives each rotor 18 by the AC voltage obtained from each inverter 56. The load 36 may further include a converter 58. The converter 58 steps down the DC voltage coming from the smoothing capacitor 38 or the battery 34 and outputs the voltage to a cooling device (not shown) and the like.

The voltage supply line ML branches to the plurality of voltage supply lines PL by a shared bus 62. In the example shown in FIG. 2, the shared bus 62 connects each battery 34 in parallel with each load 36 with respect to the smoothing capacitor 38.

A connection/disconnection unit 64 is placed on the voltage supply line ML between the smoothing capacitor 38 and the shared bus 62. The connection/disconnection unit 64 has contactors 64a, 64b. The contactor 64a is provided on the positive electrode wiring MLP of the voltage supply line ML. The contactor 64b is provided on the negative electrode wiring MLN of the voltage supply line ML.

When the contactors 64a, 64b are turned on, the smoothing capacitor 38 and the loads 36 or the batteries 34 can be connected. In that case, the DC voltage can be supplied to the loads 36 or the batteries 34. When the contactors 64a, 64b are turned off, the connection of the smoothing capacitor 38 with the loads 36 and the batteries 34 can be disconnected. In that case, the supply of DC voltage to the loads 36 and the batteries 34 can be cut off. The connection/disconnection unit 64 may have only one of the contactors 64a and 64b.

One connection/disconnection unit 66 is arranged on one voltage supply line PL. Two connection/disconnection units 66 are shown in FIG. 2. Each connection/disconnection unit 66 is disposed between the shared bus 62 and each load 36 and also each battery 34. The connection/disconnection unit 66 has contactors 66a and 66b. The contactor 66a is provided on the positive electrode wiring PLP of the voltage supply line PL. The contactor 66b is provided on the negative electrode wiring PLN of the voltage supply line PL.

When the contactors 66a, 66b are turned on, the smoothing capacitor 38 and the loads 36 or batteries 34 can be connected. In that case, the DC voltage can be supplied to the load 36 or the battery 34. When the contactors 66a, 66b are turned off, the connection of the smoothing capacitor 38 with the loads 36 and batteries 34 can be disconnected. In that case, the supply of the DC voltage to the loads 36 and the batteries 34 can be cut off. Note that the connection/disconnection unit 66 may have only one of the contactors 66a, 66b.

Each battery 34 may supply the DC voltage to the load 36 through a connection/disconnection unit 72. Two connection/disconnection units 72 are shown in FIG. 2. Each connection/disconnection unit 72 is located between each battery 34 and each voltage supply line PL. The connection/disconnection unit 72 has contactors 72a and 72b and a precharge circuit 72c.

The contactor 72a is provided on the positive electrode wiring 72p of the connection/disconnection unit 72. The contactor 72b is provided on the negative electrode wiring 72n of the connection/disconnection units 72. When the contactors 72a, 72b are turned on, the DC voltage can be supplied from the battery 34 to the load 36. When the contactors 72a and 72b are turned on at the start of the power generation unit 32, the DC voltage can be supplied from the battery 34 to the smoothing capacitor 38 as described later.

The precharge circuit 72c is provided in parallel with the contactor 72b. The precharge circuit 72c has a contactor 72d and a resistor 72e connected in series with each other. The connection/disconnection unit 72 may have only the contactor 72b and the precharge circuit 72c. The precharge circuit 72c may be provided in parallel with the contactor 72a. In this case, the connection/disconnection unit 72 may have only the contactors 72a and the precharge circuit 72c.

The voltage supply device 28 has a plurality of diodes 80. Each of the plurality of diodes 80 is located on each voltage supply line PL between the connection/disconnection unit 66 and each load 36 and also each battery 34. The diode 80 allows the supply of the DC voltage from the smoothing capacitor 38 to the load 36 or the battery 34. The diode 80 also prevents current from flowing between the batteries 34 via the connection/disconnection units 66.

The voltage supply device 28 has a plurality of switching elements 82. The switching element 82 is, for example, an IGBT (Insulated Gate Bipolar Transistors). Each of the plurality of switching elements 82 is connected in parallel with the diode 80 on each voltage supply line PL with respect to each battery 34.

The switching element 82 is turned on, whereby the smoothing capacitor 38 and the battery 34 are connected. The switching element 82 is turned on before the power generation unit 32 starts power generation, whereby the smoothing capacitor 38 and the battery 34 can be electrically connected. Therefore, power supply from the battery 34 to the smoothing capacitor 38 is enabled. At the start of the power generation unit 32, the power generation unit 46 functions as a starter to start the internal combustion engine 44. The power generation unit 46 starts the internal combustion engine 44 using the power supplied to the smoothing capacitor 38.

As described above, the voltage supply device 28 has the connection/disconnection units 64 and 66 capable of disconnecting the connection between the smoothing capacitor 38 and the loads 36 and also the batteries 34. Suppose that at least some of the connection/disconnection units 64, 66 are turned off unintentionally while the power generation unit 32 is generating power. In that case, the connection between the smoothing capacitor 38 and the loads 36 and also the batteries 34 is disconnected, and therefore, it is possible that the smoothing capacitor 38 come into the overvoltage state. The same is true when a fuse (not shown) is arranged around the connection/disconnection units 64, 66 and the fuse blows.

When the smoothing capacitor 38 comes into the overvoltage state, it is necessary to suppress or stop power generation by the power generation unit 32 at an early stage. Conventionally, the voltage across the terminals of the smoothing capacitor 38 is monitored to judge whether the smoothing capacitor 38 is in the overvoltage state. The voltage across the terminals of the smoothing capacitor 38 during power generation by the power generation unit 32 mounted on the aircraft 10 is a high voltage, for example, 1000 V.

As a threshold for the overvoltage judgment of the smoothing capacitor 38, a threshold 1010 [V] is used, considering, for example, an error ratio of 1% is taken into account with respect to a voltage across terminals of 1000 [V]. Because the error corresponding to the error ration 1% is a relatively large value of 10 [V], the required time for the overvoltage judgment is delayed by that amount. Therefore, the power generation of the power generation unit 32 cannot be suppressed or stopped at an early stage, there is a possibility that the smoothing capacitor 38 may fail.

Moreover, because it is necessary to allow a margin of 10 [V] in the capacity of the smoothing capacitor 38, the voltage supply device 28 may become larger as the capacity of the smoothing capacitor 38 increases.

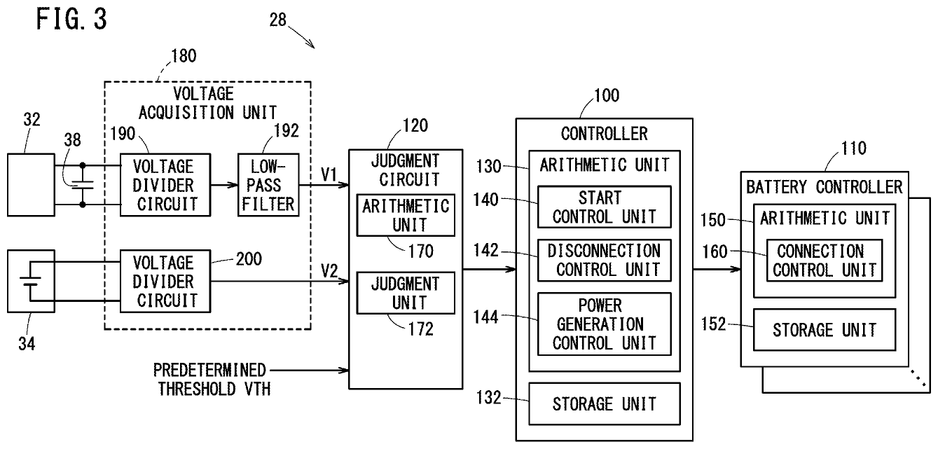

FIG. 3 is a diagram for explaining the power generation control method according to the present embodiment. As shown in FIG. 3, the voltage supply device 28 according to the present embodiment further includes a controller 100, one or more battery controllers 110, and a judgment circuit 120. The controller 100 has an arithmetic unit 130 and a storage unit 132. The arithmetic unit 130 includes a processor such as a CPU (Central Processing Unit) or a GPU (Graphics Processing Unit). That is, the arithmetic unit 130 includes processing circuitry.

The storage unit 132 includes volatile memory such as RAM (Random Access Memory) and non-volatile memory such as ROM (Read Only Memory) or flash memory. The volatile memory is used as working memory for processors. The non-volatile memory stores programs that the processor executes and other necessary data.

The arithmetic unit 130 has a start control unit 140, a disconnection control unit 142, and a power generation control unit 144. The arithmetic unit 130 executes the programs stored in the storage unit 132, whereby the start control unit 140, the disconnection control unit 142, and the power generation control unit 144 are realized. At least part of the start control unit 140, the disconnection control unit 142, and the power generation control unit 144 may be realized by an integrated circuit such as an ASIC (Application Specific Integrated Circuit) or FPGA (Field Programmable Gate Array), or an electronic circuit including a discrete device.

Before the power generation unit 32 starts power generation, the start control unit 140 controls the battery controller 110 to turn on both the contactors 72a, 72b of the connection/disconnection unit 72 and the switching element 82. The start control unit 140 also turns on the contactors 64a, 64b of the connection/disconnection unit 64 and the contactors 66a, 66b of the connection/disconnection unit 66. As a result, power is supplied from the battery 34 to the smoothing capacitor 38.

The start control unit 140 controls the power generation unit 46 as a starting device, and the power supplied to the smoothing capacitor 38 is used to rotate the power generation unit 46 to start the internal combustion engine 44. Because the smoothing capacitor 38 may discharge electricity while the power generation unit 32 is stopped, the life of the smoothing capacitor 38 can be prolonged. When the start of the internal combustion engine 44 is completed, the start control unit 140 controls the battery controller 110 to turn off the switching element 82.

In the example shown in FIG. 2, two voltage supply lines PL are shown. It is assumed that an abnormality occurs in one of the two voltage supply lines PL while the power generation unit 32 is generating power. In that case, it is necessary to disconnect the voltage supply line PL where the abnormality has occurred in order to prevent the abnormality from affecting the other normal voltage supply line PL.

Therefore, the disconnection control unit 142 shown in FIG. 3 turns off the contactors 66a, 66b of the connection/disconnection unit 66 corresponding to the voltage supply line PL in which the abnormality has occurred. This can protect the normal voltage supply line PL. In order to protect the smoothing capacitor 38 from the abnormality of the voltage supply line PL, the disconnection control unit 142 may turn off the contactors 64a, 64b of the connection/disconnection unit 64.

When the judgment circuit 120 judges that the smoothing capacitor 38 is in an overvoltage state, the power generation control unit 144 controls the power generation unit 32 to suppress or stop the power generation by the power generation unit 32.

As described above, voltage supply device 28 has one or more battery controllers 110. One battery controller 110 is provided for one battery 34. The battery controller 110 has an arithmetic unit 150 and a storage unit 152. The arithmetic unit 150 includes a processor such as a CPU or a GPU. That is, the arithmetic unit 150 includes processing circuitry.

The storage unit 152 includes volatile memory such as RAM and non-volatile memory such as ROM or flash memory. The volatile memory is used as working memory for processors. The non-volatile memory stores programs that the processor executes and other necessary data.

The arithmetic unit 150 has a connection control unit 160. The connection control unit 160 is implemented by the arithmetic unit 150 executing the program stored in the storage unit 152. The connection control unit 160 may be implemented by an integrated circuit such as an ASIC or FPGA, or an electronic circuit including a discrete device.

The connection control unit 160 turns on the contactors 72a, 72b of the connection/disconnection unit 72 and the switching element 82 according to the control by the start control unit 140 of the controller 100. When the start of the internal combustion engine 44 is completed, the connection control unit 160 turns off the switching element 82 according to the control by the start control unit 140.

The judgment circuit 120 shown in FIG. 3 is an electronic circuit (second circuit) such as an integrated circuit and includes an arithmetic unit 170 and a judgment unit 172. The arithmetic unit 170 computes the difference between first voltage V1 and second voltage V2 output from a voltage acquisition unit 180 described later and outputs voltage V3 corresponding to the difference (V3=V1−V2) to the judgment unit 172. The first voltage V1 is the voltage of the smoothing capacitor 38. The second voltage V2 is the voltage of the battery 34.

The voltage V3 corresponding to the difference between the first voltage V1 and the second voltage V2 corresponds to the voltage drop caused by the circuit elements between the smoothing capacitor 38 and the battery 34. The voltage V3 is, for example, 5 [V], which is extremely lower than the voltage across the terminals of the smoothing capacitor 38 (for example, 1000 [V]), which takes a high voltage value.

The voltage V3 and voltage obtained from a Zener diode and the like (not shown) are input to the judgment unit 172. The value of the voltage input from the Zener diode and the like to the judgment unit 172 corresponds to a predetermined threshold Vth for the overvoltage judgment of the smoothing capacitor 38. When the voltage V3 is equal to or higher than the predetermined threshold Vth, the judgment unit 172 judges that the smoothing capacitor 38 is in an overvoltage state. The judgment unit 172 outputs a signal indicating the result of the overvoltage judgment to the power generation control unit 144 of the controller 100.

A setting value of the predetermined threshold Vth is determined in advance based on the amount of voltage drop between the smoothing capacitor 38 and the battery 34 and a predetermined variation ratio. The amount of voltage drop between the smoothing capacitor 38 and the battery 34 corresponds to the voltage V3 corresponding to the difference between the first voltage V1 and the second voltage V2. When the voltage V3 is 5 [V], which is extremely low as described above, for example, the error rate 18 is considered, and the predetermined threshold Vth is set to 5.05 [V].

The error component corresponding to an error ratio of 1% considered in the setting of the predetermined threshold Vth is 0.05 [V], which is an extremely small value. Therefore, according to the present embodiment, the required time for the overvoltage judgment becomes shorter than that in the case where the voltage across the terminals of the smoothing capacitor 38 is monitored as described above. Moreover, since the capacity enlargement of the smoothing capacitor 38 can be avoided as described above, the size enlargement of the voltage supply device 28 can be suppressed.

The voltage acquisition unit 180 shown in FIG. 3 is realized by an electronic circuit (first circuit) such as an integrated circuit. However, the voltage acquisition unit 180 may be realized by a processor such as a CPU or a GPU executing a program. The voltage acquisition unit 180 has a voltage divider circuit 190 for acquiring the first voltage V1, a low-pass filter 192, and a voltage divider circuit 200 for acquiring the second voltage V2.

The voltage divider circuit 190 outputs a voltage corresponding to the voltage across the terminals of the smoothing capacitor 38. Because the smoothing capacitor 38 is connected to the power generation unit 32, high-frequency noise may occur in the voltage output from the voltage divider circuit 190. A low-pass filter 192 removes the high frequency noise. This provides a highly accurate first voltage V1. In this way, the first voltage V1 is acquired by the voltage acquisition unit 180.

The voltage divider circuit 200 outputs a voltage corresponding to the voltage across the terminals of the battery 34. The second voltage V2 is thus acquired by the voltage acquisition unit 180. The first voltage V1 and the second voltage V2 acquired by the voltage acquisition unit 180 are input to the above-described judgment circuit 120, whereby the overvoltage judgment of the smoothing capacitor 38 is performed.

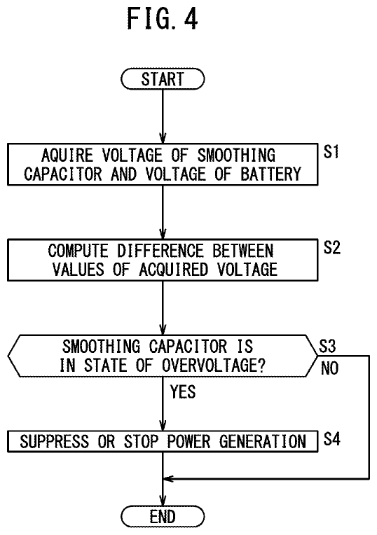

FIG. 4 is a flowchart showing the processing procedure according to the power generation control method. This processing procedure is repeatedly performed by, for example, the voltage acquisition unit 180, the judgment circuit 120, and the arithmetic unit 130 of the controller 100. When the processing procedure is started, in step S1, the voltage acquisition unit 180 acquires the first voltage V1 of the smoothing capacitor 38 and the second voltage V2 of the battery 34. In step S2, the arithmetic unit 170 of the judgment circuit 120 computes the difference between the first voltage V1 and the second voltage V2 acquired in step S1.

In step S3, the judgment unit 172 of the judgment circuit 120 judges whether the smoothing capacitor 38 is in a state of overvoltage based on whether the difference compute d in step S2 is equal to or larger than a predetermined threshold Vth. If YES in step S3, the procedure proceeds to step S4. If NO in step S3, the processing procedure ends.

In step S4, the power generation control unit 144 controls the power generation unit 32 to suppress or stop power generation by the power generation unit 32. When the process of step S4 is completed, the present processing procedure ends.

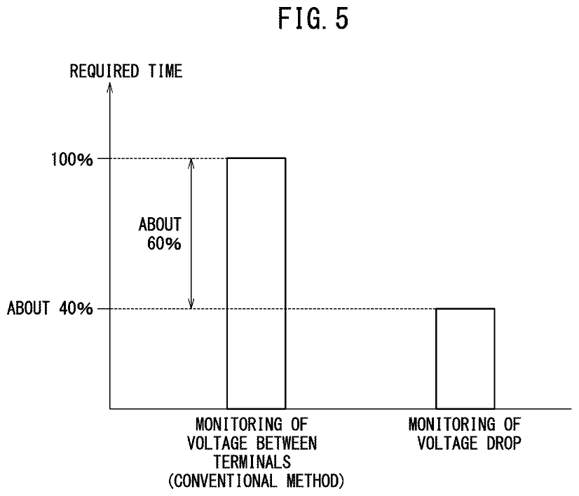

FIG. 5 is a diagram exemplifying a change in the required time for the power generation control associated with an overvoltage judgment. As described above, when the voltage drop is monitored as in the present embodiment, the required time for the overvoltage judgment becomes shorter than when the voltage between the terminals of the smoothing capacitor 38 is monitored as in the prior art. According to the experiments, the required time from when the connection/disconnection unit 64 or 66 is turned off while the power generation unit 32 is generating power to when the power generation by the power generation unit 32 is suppressed or stopped is about 60% shorter.

### Modified Example

The above embodiment may be modified as follows.

Both the voltage acquisition unit 180 and the judgment circuit 120 in the above embodiment are electronic circuits such as integrated circuits. However, the voltage acquisition unit 180, the arithmetic unit 170 of the judgment circuit 120, and the judgment unit 172 may be implemented in, for example, one computer. In this case, the voltage acquisition unit 180, the arithmetic unit 170 of the judgment circuit 120, and the judgment unit 172 are realized by a processor such as a CPU or a GPU of a computer executing a program. The voltage acquisition unit 180 acquires the first voltage V1 from the voltage sensor that detects the first voltage V1, and acquires the second voltage V2 from the voltage sensor that detects the second voltage V2.

### Inventions Obtained from the Embodiments

The following notes are disclosed for the inventions that can be understood from the above embodiments and modified examples.

### Supplemental Note 1

A voltage supply device (28) for supplying direct-current voltage generated by a power generation unit (32) to a load (36) comprises a smoothing capacitor (38) that smooths the direct-current voltage, a battery (34) connected to the smoothing capacitor in parallel with the load, a voltage acquisition unit (180) that acquires a first voltage (V1) that is voltage of the smoothing capacitor, and a second voltage (V2) that is voltage of the battery, an arithmetic unit (170) that computes a difference between the first voltage and the second voltage, a judgment unit (172) that judges that the smoothing capacitor is in an overvoltage state when the difference is equal to or greater than a predetermined threshold (Vth), and a power generation control unit (144) that controls the power generation unit to suppress or stop power generation by the power generation unit when it is judged that the smoothing capacitor is in the overvoltage state. This can suppress the enlargement of the voltage supply device.

### Supplemental Note 2

The voltage supply device according to Supplemental Note 1 may further include a connection/disconnection unit (64, 66) that is disposed between the smoothing capacitor and the battery and is configured to disconnect a connection between the smoothing capacitor and the battery. This can protect a normal voltage supply line or a smoothing capacitor.

### Supplemental Note 3

The voltage supply device according to Supplemental Note 1 may further include a start control unit (140) that controls a switching element (82) located between the smoothing capacitor and the battery to connect the smoothing capacitor and the battery with each other before the power generation unit starts power generation. This allows the smoothing capacitor to discharge while the power generation unit is stopped, thus extending the life of the smoothing capacitor.

### Supplemental Note 4

Regarding the voltage supply device according to Supplemental Note 1, the predetermined threshold may be predetermined based on an amount of voltage drop between the smoothing capacitor and the battery and a predetermined variation ratio. This reduces the required time for an overvoltage judgment.

### Supplemental Note 5

The voltage supply device according to any of Supplemental Notes 1 to 4 may further include a low-pass filter (192) that removes a high-frequency component of the voltage of the smoothing capacitor, wherein the voltage acquisition unit may acquire, as the first voltage, the voltage of the smoothing capacitor from which the high-frequency component has been removed. This provides a highly accurate first voltage.

### Supplemental Note 6

A power generation control method for a voltage supply device that supplies direct-current voltage generated by a power generation unit to a load may include a voltage acquisition step of acquiring a first voltage that is the voltage of a smoothing capacitor that smooths the direct-current voltage, and a second voltage that is the voltage of a battery connected to the smoothing capacitor in parallel with the load, a computing step of computing the difference between the first voltage and the second voltage, a judgment step of judging that the smoothing capacitor is in an overvoltage state when the difference is equal to or larger than a predetermined threshold, and a power generation control step of controlling the power generation unit to suppress or stop power generation by the power generation unit when it is judged that the smoothing capacitor is in the overvoltage state. This can suppress the enlargement of the voltage supply device.

Note that the present invention is not limited to the above disclosure, and various modifications are possible without departing from the essence and gist of the present invention.

1. A voltage supply device for supplying direct-current voltage generated by a power generation unit to a load, the voltage supply device comprising:
a smoothing capacitor that smooths the direct-current voltage;
a battery connected to the smoothing capacitor in parallel with the load;
a first circuit that acquires a first voltage that is voltage of the smoothing capacitor and a second voltage that is voltage of the battery;
a second circuit that computes a difference between the first voltage and the second voltage and judges that the smoothing capacitor is in an overvoltage state when the difference is equal to or greater than a predetermined threshold; and
one or more processors that execute computer-executable instructions stored in memory,
wherein the one or more processors executes the computer-executable instructions to cause the voltage supply device to control the power generation unit to suppress or stop power generation by the power generation unit when the second circuit judges that the smoothing capacitor is in the overvoltage state.

2. The voltage supply device according to claim 1,
further comprising a connection/disconnection unit that is disposed between the smoothing capacitor and the battery and is configured to disconnect a connection between the smoothing capacitor and the battery.

3. The voltage supply device according to claim 1, wherein
the one or more processors executes the computer-executable instructions to cause the voltage supply device to control a switching element located between the smoothing capacitor and the battery to connect the smoothing capacitor and the battery with each other before the power generation unit starts power generation.

4. The voltage supply device according to claim 1, wherein
the predetermined threshold is predetermined based on an amount of voltage drop between the smoothing capacitor and the battery and a predetermined variation ratio.

5. The voltage supply device according to claim 1,
further comprising a low-pass filter that removes a high-frequency component of the voltage of the smoothing capacitor,
wherein the first circuit acquires, as the first voltage, the voltage of the smoothing capacitor from which the high-frequency component has been removed.

6. The voltage supply device according to claim 1,
further comprising a connection/disconnection unit that is disposed between the smoothing capacitor and the load and is configured to cut off supply of the direct-current voltage to the load,
wherein the difference becomes equal to or larger than the predetermined threshold by the one or more processors turning off the connection/disconnection unit.

7. A power generation control method for a voltage supply device that supplies direct-current voltage generated by a power generation unit to a load, the power generation control method comprising:
acquiring a first voltage that is voltage of a smoothing capacitor that smooths the direct-current voltage, and a second voltage that is voltage of a battery connected to the smoothing capacitor in parallel with the load;
computing a difference between the first voltage and the second voltage;
judging that the smoothing capacitor is in an overvoltage state when the difference is equal to or larger than a predetermined threshold; and
controlling the power generation unit to suppress or stop power generation by the power generation unit when it is judged that the smoothing capacitor is in the overvoltage state.
